(19) United States
(12) Patent Application Publication
(10) Pub. No.: US 2002/0073345 A1
(43) Pub. Date: Jun. 13, 2002

(54) Secure indentification method and apparatus

(76) Inventor: Joseph Esfahani, Holon (IL)

Correspondence Address: G. E. EHRLICH (1995) LTD., ANTHONY CASTORINA, SUITE 207, 2001 JEFFERSON DAVIS HIGHWAY, ARLINGTON, VA, 22202, US

(21) Appl. No.: 10/003,268

(22) Filed: Dec. 6, 2001

Related U.S. Application Data
(60) Provisional application No. 60/254,171, filed on Dec. 11, 2000.

(51) Int. Cl. H04L 9/32

(52) U.S. Cl. 713/202; 713/182

(57) ABSTRACT

Secure identification system for remote identification of parties to a transaction. The system comprises: a user key generator for generating a user manageable identification sequence using a user identification code, time changing information and an encryption function; a user interface firstly for receiving user information which is sufficient to identify the user identification code, and secondly for receiving the user manageable identification sequence itself; a database comprising respective user identification codes and corresponding cryptographic functions; and an identification processor for determining whether the identification sequence comprises the respective identification code, thereby to carry out secure identification of the respective user for authorization of the transaction.

### RELATIONSHIP TO EXISTING APPLICATIONS

The present application claims priority from U.S. Provisional Patent Application No. 60/254,171 filed Dec. 11, 2000.

### FIELD OF THE INVENTION

The present invention relates to secure identification and more particularly but not exclusively to secure identification for carrying out remote transactions and network-based activities where identification is needed.

### BACKGROUND OF THE INVENTION

Today more and more transactions are carried out remotely and more and more activities require identification of a user. Practical identification methods are required to be rapid, secure, applicable to large numbers of people and possible to carry out remotely. In order to be considered secure, the identification method should be immune to eavesdropping and impersonation, by others, of the legitimate user.

Currently various methods for identification are used, such as users being assigned passwords or PIN numbers. Users may be given credit cards or smart cards which can be read to obtain identification information, and cards are available which have security I.C.s which create identification sequences with a high degree of encryption.

Of the various identification methods, those involving credit cards are the most versatile. A credit card can be used for transactions over the Internet and for transactions using ATM machines, as well as over the counter transactions and telephone transactions. On the Internet it is common to use secure links, generally involving encryption and secure digital signatures, so that credit card numbers cannot be read and users cannot be impersonated. There are numerous methods for generating such encryption and secure digital signatures on the Internet, but such methods generally operate transparently to users, not inspiring the confidence to let the user reveal his credit card number. Furthermore, such systems are vulnerable to certain types of attack, such as Trojan horse attacks, which give away the user's encryption keys, or obtain confidential information prior to its being encrypted.

Thus, there is a both a perceived and a real weakness as regards secure links, which discourages users from entering their credit card numbers for use on an open network. Aside from a padlock icon appearing on their screen there is no indication to the user that encryption is taking place, or what kind or strength of encryption, and there is no way of reassuring the user that a Trojan horse program is not giving away his passwords or unencrypted account information. Thus, there is a widespread reluctance among users to allow their credit card numbers to be used over the Internet or like electronic connections.

It is thus desirable to provide a means of carrying out transactions over an open electronic link, which does not require the user to reveal his credit card number over the link, and which is not vulnerable to Trojan horse attack.

### SUMMARY OF THE INVENTION

Embodiments of the present invention aim to solve the drawbacks of the prior art, and in particular to provide secure identification sequences that are easily user manipulated and which are thus available for identification purposes regardless of whether there is an end to end electronic connection, hence being invulnerable to Trojan horse attack. Embodiments of the invention further provide a once-only transaction-specific validation number that may be used in place of a credit card number, thus allowing for electronic transactions even amongst users who are reluctant to commit their credit card numbers to the Internet.

According to a first aspect of the present invention there is thus provided secure identification apparatus for remote transaction enablement, the apparatus comprising:

a user interface having a first input part for receiving user information of a respective user, and a second input part for receiving an identification sequence comprising an encryption of a combination of a user identifying element and a time varying element,

a database of identification sequencing information for a plurality of users, the sequencing information corresponding to at least the user identifying element,

an identification processor, associated with the user interface and the database, for determining whether the identification sequence comprises a user identifying element corresponding to the respective user, and

a transaction validation unit, for using the determination to enable a transaction.

Preferably, the transaction validation unit is operable to enable the transaction by using the identifying element to obtain an account number of a user with a transaction service provider.

Preferably, the identification sequence is a sequence of up to sixteen characters. Alternatively even smaller sequences can be used, for example four.

Preferably, the identification sequence is a sequence arrangeable into a credit card number format.

Preferably, the sequencing information further comprises the cryptographic function.

Preferably, the cryptographic function is a reversible function and the identification processor comprises functionality for carrying out the cryptographic function in reverse to obtain the identification code.

Preferably, the cryptographic function comprises a one-to-one reversible function.

Alternatively, the cryptographic function comprises a one-to-one trapdoor function.

As a further alternative, the cryptographic function comprises an irreversible function, the identification processor being operable to insert the identification code and the time varying information into the cryptographic function to attempt to reproduce the user manageable identification sequence.

According to a second aspect of the present invention there is provided a method of secure identification for remotely enabling a transaction, the method comprising:

receiving user information input,

receiving a user manageable identification sequence,

using the user information input to retrieve corresponding sequencing information,

processing the sequencing information to determine whether it corresponds with the received user-manageable identification sequence,

assigning a positive outcome to the identification if the identification sequence is found to correspond with the retrieved sequencing information, and

enabling the transaction if the outcome is positive.

Preferably, the step of enabling the transaction comprises:

obtaining valid account information of a user, using the identification information, and

providing to a transaction service provider the valid account information.

Preferably, the valid account information is in the format of a credit card number.

Preferably, the identification sequence is a sequence of up to sixteen characters.

Preferably, the user manageable sequence is a sequence of up to four characters.

Preferably, the sequence is a sequence arrangeable into a credit card number format.

Preferably, the sequencing information comprises an identification code associated with the respective user, time changing information and a cryptographic function.

Preferably, the processing sequence information comprises carrying out the cryptographic function in reverse to obtain the identification code.

Preferably, the cryptographic function comprises a one-to-one reversible function.

Alternatively, the cryptographic function comprises a one-to-one trapdoor function.

Preferably, the cryptographic function is an irreversible function, the identification processor being operable to insert the identification code and the time varying information into the cryptographic function to attempt to reproduce the user manageable identification sequence.

According to a third aspect of the present invention there is provided a secure identification system for enabling of remote transactions, the system comprising:

a user key generator for generating an identification sequence, using a user identification code, time changing information and an encryption function,

a user interface having a first input part for receiving user information of a respective user, and a second input part for receiving the identification sequence,

a database comprising user information and corresponding user identification codes and cryptographic functions,

an identification processor, associated with the user interface and the database, for using the cryptographic function to determine whether the identification sequence comprises a respective identification code corresponding to the user information, thereby to carry out secure identification of the respective user, and

a transaction number database associated with the identification processor, for using the identification code to obtain user account information for passing to a transaction service provider.

Preferably, the identification sequence is a sequence of up to sixteen characters.

In one preferred embodiment, the sequence is a sequence of up to four characters.

In a particularly preferred embodiment, the sequence is a sequence arrangeable into a credit card number format.

Preferably, the sequence is a user-manageable sequence.

Preferably, the user identification code comprises a time constant element.

Preferably, the identification processor comprises functionality for carrying out the cryptographic function in reverse to obtain the identification code.

Preferably, the cryptographic function comprises a one-to-one reversible function.

As an alternative, the cryptographic function comprises a one-to-one trapdoor function or an irreversible function.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a simplified diagram showing a system for providing secure identification for remote transaction authorization according to a first embodiment of the present invention,

FIG. 2 shows a secure identification sequence for use in a second embodiment of the present invention, and

FIG. 3 is a simplified flow chart showing a method of providing secure identification for transaction authorization according to a preferred embodiment of the present invention.

### DESCRIPTION OF THE PREFERRED EMBODIMENTS

According to embodiments of the present invention there is provided a secure means of identification of a user that relies on non-repeated identification codes and that does not require a generator of the codes to be connected to any network. Alternatively or additionally there is provided a system, apparatus and method which provides a one time credit card number authorized for a given transaction only.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

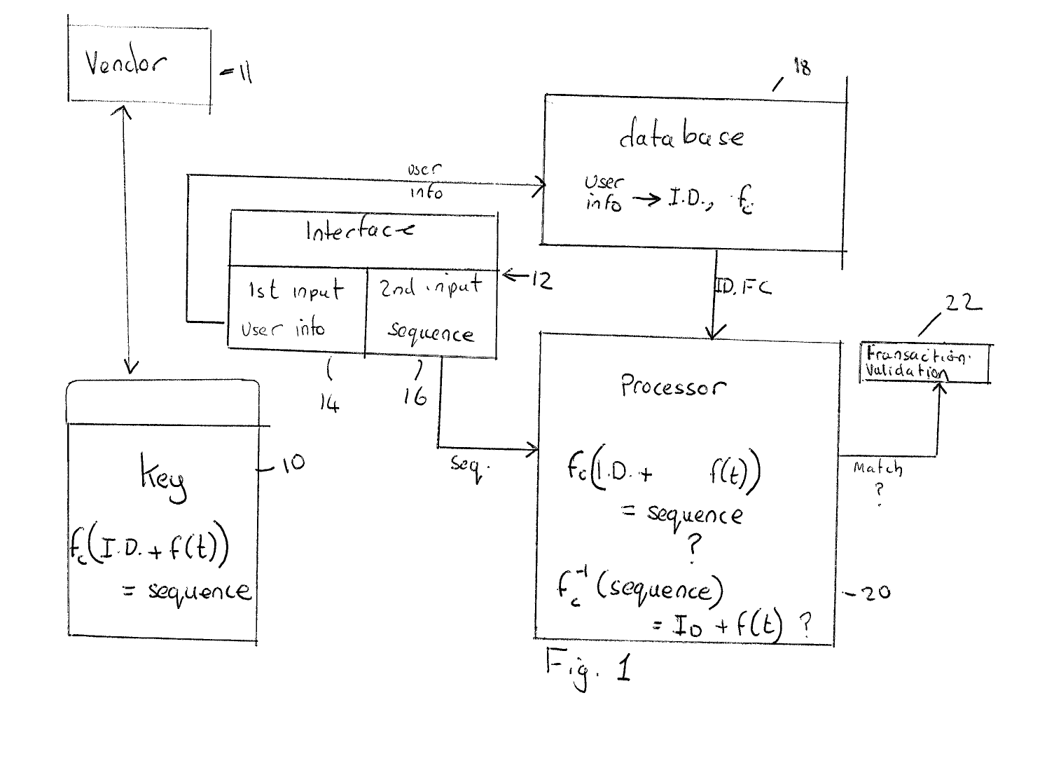

Reference is now made to FIG. 1, which is a simplified block diagram showing a system for remote authorization of a transaction according to a first preferred embodiment of the present invention. In FIG. 1, a key generator 10 is held by a user for generation of transaction keys. The key generator preferably does not require to be connected to any network in order to be useful in transaction authorization processes. The key generator may nevertheless have a network connection for optional use. An advantage of not being connected to the network is that the key generator 10 is not vulnerable to hacking attacks, in particular being immune to attacks of the Trojan horse variety.

The key generator 10 is preferably pre-programmed with a cryptographic function f_{c} and with a user-identifying element ID such as a user specific code, and is also able to generate time varying information to form a time varying element. The user may operate the device by entering a password. The device then combines the time bearing element f(t) with the user-specific key ID and encrypts them using the cryptographic function f^{c} to form a sequence seq.

Preferably the key generator 10 changes the time varying element frequently, typically around twice a minute, and in a particular prototype, once every 36 seconds. Again, preferably, the output sequence is not repeated.

The sequence seq. is preferably a sequence of a form that is easy for a user to manipulate manually. Generally speaking, existing sequences of similar type are long and not practical for manual manipulation by lay users, and thus prior art systems require an electronic connection, thereby compromising on security and also restricting use of the system to circumstances in which a compatible connection can be made. In one preferred embodiment, the sequence is entirely numeric, whilst in other embodiments it may be alphanumeric. The advantage of the alphanumeric sequence is the vast increase in possible combinations. The advantage of the purely numeric sequence is that it is practical for use with telephone keypads. Only a minority of present day users is likely to be prepared to enter an alphanumeric sequence via a telephone keypad. In a particularly preferred embodiment, the sequence seq. is a 16 digit number formatted as a credit card number. The sequence may then be entered in the credit card space on a web form or given over the telephone, to a vendor 11.

In a preferred embodiment, the sequence is arrived at by combining the date and time with the device ID, then multiplying by (or raising to the power of) a constant, and then adding to a user password, thus

Seq=((date+time+device ID)×256)+password.

The system further comprises an interface 12 having a first input part 14 for receiving user information of a respective user, such as a username, or a username and password, or an account number or anything that can identify the particular user for searching in a database. The interface preferably has a second input part 16 for receiving the user manageable identification sequence seq. As explained above, the sequence preferably comprises an encryption of a combination of at least a user identifying element and a time varying element. Other elements may be included in the encryption but are not preferred since, as discussed above, it is preferable to keep the encrypted sequence short.

The interface 12 may be a form located on a website. Alternatively it can be a part of any other data capture technique on any kind of electronic system. For example, it could be part of an automatic telephone answering system in which data is entered by pressing keys or by voice processing technology. The interface may receive its data directly from the user, or it may receive its data from the vendor 11, who uses it as a credit card authorization scheme.

The interface 12 is preferably associated with a database 18. The database preferably comprises a user information field, which contains data identifying individual users or user accounts. The data in the first field preferably corresponds to the data requested by the first input part 14 of the interface 12. It is noted that neither the user information requested by the Interface 12, nor the information stored in the user database 18 comprises any of the user's sensitive account information.

A second field of the database 18 comprises the user's ID and his assigned cryptographic function fc or the complement or inverse cryptographic function in the case of fc being a two-way function. The above two items of information constitute the identification sequencing information for a given user. The database is operable to retrieve the identification sequencing information that corresponds to the user information received from the interface.

An identification processor is preferably connected to the output of database 18, and to the second field 16 of the user interface 12. The relevant identification sequencing information is preferably retrieved from the database, as described above, and passed to the identification processor 20. The identification processor at the same time receives the sequence seq. from the user interface. In one embodiment, where the cryptographic function is a reversible function, the inverse of the cryptographic function is simply applied to the sequence to produce a decrypted sequence. The user ID is then searched for within the decrypted sequence, all other content of the decrypted sequence, such as the time varying element, being ignored. If the ID is found within the encrypted sequence, a flag is set to indicate a match, and transaction unit 22 preferably connects to a transaction service provider, such as a credit card issuer, to indicate that the user has been successfully identified. Preferably, the transaction unit 22 has a database holding the actual credit card numbers for each of the users. The correct credit card number is thus selected and sent to the card issuer together with details of the transaction, and is authorized as if it were a conventional authorization request originating from the vendor. Thus authorization is carried out, using the correct credit card number, but without the user's credit card number being exposed on the open network.

The transaction unit need not be limited to carrying out authorizations for credit card type accounts, but rather may carry out authorizations for any kind of account and also any other kind of authorization, like authorizing access to recognized users and the like.

Returning to the processor 20, it is noted that the above-described algorithm applies to a reversible function and to a trap-door function, with the provision that the description of the function as stored in the database 18 and in the key generator 10 are not the same in the case of the trapdoor function. In the case of a conventional reversible function, the descriptions need not be the same, the database preferably describing the inverse function.

In an alternative preferred embodiment of the present invention, the cryptographic function is an irreversible function. In such a case, it is not possible to take the encrypted sequence and arrive at the decrypted sequence. Instead, the standard procedure is to repeat the encryption procedure to determine whether the same answer is reached. In such a case, the time varying element is preferably provided from the key generator in plain text as well as within the encrypted sequence, and may be supplied to the interface 12. In order to test whether the sequence comes from the given user's key generator, the ID from the database is combined with the time varying information from the interface and the cryptographic function is applied thereto. If the result is the same as the sequence seq. then a positive identification is made.

The operation of number issuing unit 22 is the same as in the previous embodiment.

The authorization unit 22 is preferably connected to a credit card payment arrangement. The payment arrangement may check that the respective user is permitted to make the transaction from the point of view of his account status and then authorizes the transaction in the usual way.

In an alternative embodiment, the user does not initiate the authorization procedure through the vendor. Instead he turns directly to the interface 12 with a code obtained from a key generator as before. The code is processed as described above for decryption and identification and then the authorization unit issues a one time transaction number in the format of a credit card number. The new credit card number is provided back through the interface 12 to the user, who then provides it in the normal way wherever he wishes to obtain goods or services. The credit card number is used in the transaction in the usual way, typically being given over a telephone, typed in over a telephone keyboard or entered into an HTML for or the like. The credit card number is preferably approved for a single transaction only and thus allows the user to make use of standard credit card transaction apparatus without giving away his personal account information.

In a simplification of the above embodiment, the key generator 10 may issue the sequence seq. in credit card format. The authorization unit 22, rather than actively issuing a number, receives the seq. number from the key generator and registers it as a one-time transaction number. The user then simply provides the number, as if it were a normal credit card number, to the supplier of goods or services who authorizes, in the normal way, a one time credit card number.

In a further preferred embodiment, the Interface 12 further allows the user to enter additional transaction details such as the transaction amount, so that the one time credit card number may be approved for that amount alone. Thus an eavesdropper attempting to steal the number would have to apply the number to a transaction for the identical amount at the identical vendor.

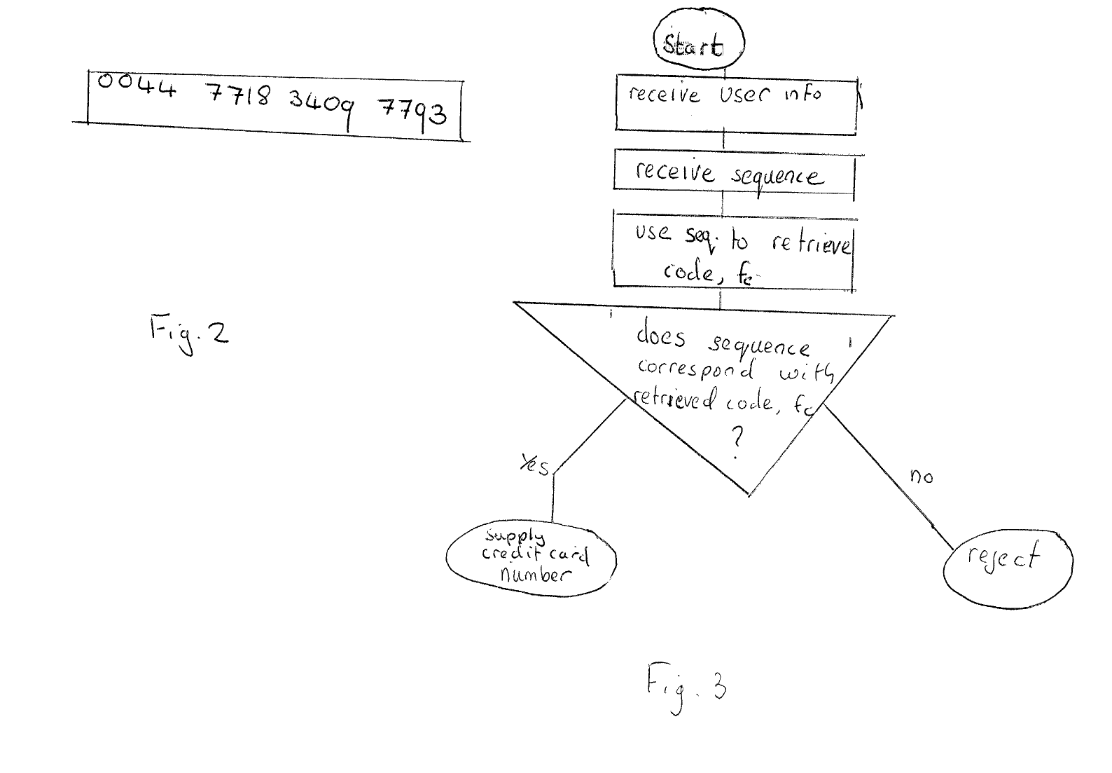

Reference is now made to FIG. 2, which shows a sequence seq. for use in a preferred embodiment of the present invention. In the embodiment the sequence is in the format of a credit card number. Thus, although the sequence is relatively long, the sequence is made more manageable and user-friendly in that it is arranged in a sequence of relatively short words, and in that the user is presumably already comfortable with the credit card format. The credit card format is particularly preferred as it works with existing Internet forms intended for credit card numbers. The key may comfortably be used via a keyboard onto a form, or recitated over a telephone link, or keyed into a telephone keypad.

Reference is now made to FIG. 3, which is a simplified diagram showing a method of providing authorization for a transaction or the like, in accordance with embodiments of the present invention.

In FIG. 3, user information is received from a user interface, along with the sequence seq. As described above, the interface information may come directly from the user, or indirectly via a vendor seeking transaction authorization. The user information is passed to a database to obtain a user ID and corresponding cryptographic information. The cryptographic may comprise a function, or may comprise a cryptographic key for use with a predetermined function, and the information is then used, as described above, to determine whether the user ID is encrypted in the sequence seq. If so the user is identified and a one-time transaction number is provided as described above. Otherwise, the identification fails. The one time transaction number may then be used to complete the transaction.

A preferred embodiment of the present invention is provided over a webpage on the Internet. From the user's point of view, the user selects a product or service and then selects a provider of the present embodiment as a payment method. The selection opens the webpage supporting the present embodiment, which provides the interface 12. The user is asked for information identifying himself, a username, a password, an account number, a telephone number, etc. or various combinations thereof. The webpage may or may not deal with actual transaction details, such as a transaction amount, as preferred.

The user then enters a password to operate his key generator, which generates a key (the sequence seq. described above), which is preferably a number having the format shown in FIG. 2. The sequence is entered in the appropriate field on the webpage.

The webpage passes the user information and the sequence to the server for the identification procedure of FIG. 3, which, if successful, culminates in the issuance of a one-time transaction number, or in release to the card issuer of the user's account details, as described above. If authorization is not successful then the user is asked to enter the various data items, such as user information and sequence once again. A threshold may be set of a maximum allowed number of unsuccessful attempts.

There are thus provided embodiments in which security measures are apparent to a user, which do not require him to reveal account information over an open network, which are immune to digital attack including eavesdropping and Trojan horse type attacks and which are rapid and easy to use.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. Secure identification apparatus for remote transaction enablement, the apparatus comprising:
a user interface having a first input part for receiving user information of a respective user, and a second input part for receiving an identification sequence comprising an encryption of a combination of a user identifying element and a time varying element,
a database of identification sequencing information for a plurality of users, said sequencing information corresponding to at least said user identifying element,
an identification processor, associated with said user interface and said database, for determining whether said identification sequence comprises a user identifying element corresponding to said respective user, and
a transaction validation unit, for using said determination to enable a transaction.

2. The apparatus of claim 1, wherein said transaction validation unit is operable to enable said transaction by using said identifying element to obtain an account number of a user with a transaction service provider.

3. The apparatus of claim 1, wherein said identification sequence is a sequence of up to sixteen characters.

4. The apparatus of claim 1, wherein said identification sequence is a sequence of up to four characters.

5. The apparatus of claim 1, wherein said identification sequence is a sequence arrangeable into a credit card number format.

6. The apparatus of claim 1, wherein said sequencing information further comprises said cryptographic function.

7. The apparatus of claim 6, wherein said cryptographic function is a reversible function and said identification processor comprises functionality for carrying out said cryptographic function in reverse to obtain said identification code.

8. The apparatus of claim 6, wherein said cryptographic function comprises a one-to-one reversible function.

9. The apparatus of claim 6, wherein said cryptographic function comprises a one-to-one trapdoor function.

10. The apparatus of claim 6, wherein said cryptographic function comprises an irreversible function, said identification processor being operable to insert said identification code and said time varying information into said cryptographic function to attempt to reproduce said user manageable identification sequence.

11. A method of secure identification for remotely enabling a transaction, the method comprising:
receiving user information input,
receiving a user manageable identification sequence,
using said user information input to retrieve corresponding sequencing information,
processing said sequencing information to determine whether it corresponds with said received user-manageable identification sequence,
assigning a positive outcome to said identification if said identification sequence is found to correspond with said retrieved sequencing information, and
enabling said transaction if said outcome is positive.

12. The method of claim 11, wherein enabling said transaction comprises:
obtaining valid account information of a user, using said identification information, and
providing to a transaction service provider said valid account information.

13. The method of claim 1, wherein said valid account information is in the format of a credit card number.

14. The method of claim 11, wherein said identification sequence is a sequence of up to sixteen characters.

15. The method of claim 1, wherein said user manageable sequence is a sequence of up to four characters.

16. The method of claim 11, wherein said sequence is a sequence arrangeable into a credit card number format.

17. The method of claim 11, wherein said sequencing information comprises an identification code associated with said respective user, time changing information and a cryptographic function.

18. The method of claim 17, wherein said processing sequence information comprises carrying out said cryptographic function in reverse to obtain said identification code.

19. The method of claim 6, wherein said cryptographic function comprises a one-to-one reversible function.

20. The method of claim 6, wherein said cryptographic function comprises a one-to-one trapdoor function.

21. The method of claim 6, wherein said cryptographic function is an irreversible function, said identification processor being operable to insert said identification code and said time varying information into said cryptographic function to attempt to reproduce said user manageable identification sequence.

22. Secure identification system for enabling of remote transactions, the system comprising:
a user key generator for generating an identification sequence, using a user identification code, time changing information and an encryption function,
a user interface having a first input part for receiving user information of a respective user, and a second input part for receiving said identification sequence,
a database comprising user information and corresponding user identification codes and cryptographic functions,
an identification processor, associated with said user interface and said database, for using said cryptographic function to determine whether said identification sequence comprises a respective identification code corresponding to said user information, thereby to carry out secure identification of said respective user, and
a transaction number database associated with said identification processor, for using said identification code to obtain user account information for passing to a transaction service provider.

23. The system of claim 22, wherein said identification sequence is a sequence of up to sixteen characters.

24. The system of claim 22, wherein said sequence is a sequence of up to four characters.

25. The system of claim 22, wherein said sequence is a sequence arrangeable into a credit card number format.

26. The system of claim 22, wherein said sequence is a user-manageable sequence.

27. The system of claim 22, wherein said user identification code comprises a time constant element.

28. The system of claim 22, wherein said identification processor comprises functionality for carrying out said cryptographic function in reverse to obtain said identification code.

29. The system of claim 22, wherein said cryptographic function comprises a one-to-one reversible function.

30. The system of claim 22, wherein said cryptographic function comprises a one-to-one trapdoor function.

31. The system of claim 22, wherein said cryptographic function is an irreversible function, said identification processor being operable to insert said identification code and said time varying information into said cryptographic function to attempt to reproduce said user manageable identification sequence.
